(19) United States
(12) Patent Application Publication
(10) Pub. No.: US 2022/0036755 A1
(43) Pub. Date: Feb. 3, 2022

(54) Methods for grading scholastic work and providing grades, corrections of the wrong answers to students

(71) Applicant: Narong Kovathana, Chicago, IL (US)

(72) Inventor: Narong Kovathana, Chicago, IL (US)

(21) Appl. No.: 16/873,853

(22) Filed: Jul. 28, 2020

(51) Int. Cl. G09B 7/02; H04L 12/58

(52) U.S. Cl. CPC G09B 7/02; G06F 3/0481; H04L 51/08

(57) ABSTRACT

The methods employ a technique of switching one removable-storage-device (RSD) to the other to give different, data files of answers to homework questions for a computer (401, 501) to grade. The computer uses grading software with a graphical-user-interface (GUI) (201) to electronically compare data in two, different, plain, text files, namely student-files with a reference-file in electrically scoring. The reference-file contains only the data of the right answers to the homework questions. A teacher makes it, gives its file-name to match the one of its receiving-file in the grading software and stores it in an RSD (301, 302). The student-files contain class-related information as student-file-identifications, and the data of the answers believed to be the right answers of the same, homework questions. Students make them and give their file-names to match those of their receiving-files. They comprise the same word with different numbers in the ascending, numerical order as suffixes. Then, the students store their student-files temporarily in any data storages for preparing to deliver them to their teacher for grading. If they choose e-mailing to deliver their student-files, the student-file-identifications will help the teacher sort out the e-mails in his or her “Inbox.”

After the teacher has identified students' e-mails of his or her class, he or she will store the attached student-files in the e-mails together with his or her reference-file in the same RSD. After storing, the teacher will look for the discontinuity of the ascending, numerical order in the numerical suffixes in all of the file-names to determine whether or not there are any unaccountable student-files. If there are, he or she will use filler-files to substitute for them before the grading. The teacher makes the filler-files in the same way by using a word processor. They contain irrelevant data or “no” data and have the same file-names as those of the unaccountable student-files. The teacher will apply scoring a weight or weights and start grading students' work by using the GUI. The grading results will be stored in the output-files whose contents can be manually printed out. Some of the results will be included as items in a list box (205) in the GUI. The items will be visibly shown at the end of the grading.

### SEQUENCE LISTING OR PROGRAM

Not Applicable

### BACKGROUND—FIELD

This patent application relates to automatically grading methods to grade scholastic work in computer, recognizable medium, and more specifically to using a computer to assist in electronically scoring students' textual answers to questions in homework or tests.

### BACKGROUND—PRIOR ART

The following is a tabulation of some prior art that presently appears relevant:

U.S. Patents

| U.S. Pat. No. | Kind Code | Issue Date | Patentee |
|---|---|---|---|
| 9,805,615 | B2 | 2017-17-31 | Foley, Jr. |
| 6,115,683 | — | 2000 Sep. 5 | Burstein et al. |

Most people in academic communities are familiar with an automatically grading method known as “scanning.” It has been around for over a half of a century and widely used to score answers in many standardized tests. However, the scanning method for scoring answers in tests is not suitable for grading daily school-work, because in order to have answers marked at different locations on an answer sheet or response form to differentiate a correct answer from the incorrect ones, school-work questions must have multiple answers to choose from. Making or composing questions with multiple-answer options or multiple-choice questions takes a lot of time, and teachers cannot afford the time to make such questions on a daily basis.

For many years, people have been trying to find an alternative way for grading tests and homework. Due to the advancement of computer and information technologies, not too long ago, they came up with methods of using computer, recognizable media or electronic files to store school work for scoring electronically. An early example of using electronic files for scoring answers in patent records of the U.S. Patent and Trademark Office was in U.S. Pat. No. 6,115,683 issued on Sep. 5, 2000. Burstein et al. devised a system to use plain, text files to help in scoring assays. Another example of using the electronically scoring was in U.S. Pat. No. 9,805,615 issued on Oct. 31, 2017. Foley, Jr. used methods of electronically comparing data in two, different, plain, text files to score answers in tests and homework.

Foley's methods do away with using the multiple-choice questions and answer sheets, because the electronically scoring can score textual answers. Students can type up texts by using a computer-keyboard to answer the questions. However, his methods require posting tests or homework on a database server, because scoring answers electronically takes place in the server where the scoring, computer program is being executed. Thus, in order to score school work electronically, teachers have to get online to connect to the server to post tests or homework on it. This requirement makes Foley's methods of scoring answers in tests or homework unfeasible for most teachers to use, because they are unskilled in the information technology. Furthermore, when students want to take a test, they need to get online through computer terminals or desktop computers to connect to the database server to score their answers, schools may not have enough computer terminals for them to use at the same time.

In addition, students need to authenticate in order to get accesses to the database server. In this process, the server must have a quick processing speed to handle hundreds of students' authentications before a test. The database server must be able to store a lot of data and also very efficient in order to accommodate and provide data requested from hundreds of students in the same, test period. A computer installation to handle this kind of work requires a computer with a large, storage capacity and high, processing power like a mainframe computer. A mainframe computer is very expensive, and schools may not be able to afford it.

### SUMMARY

The objectives of the embodiment described in the current application is to give some solutions to the limitations and disadvantages of the prior art. It enables teachers with little or no computer, programming skills to take advantages of the quick, processing power of a computer to shorten the time in grading students' work. The grading software included in this embodiment is easy to use and does not require editing when being used for grading work from students in different classes or by different teachers, because the embodiment uses a technique of switching one RSD to the other to give different data files of answers to questions in homework for a computer to grade. More importantly, by using this grading software, teachers can still assign their homework in the usual way, i.e., giving homework from the text books. They do not need to make special, homework questions necessary for posting in a database server as other, grading methods in the prior art require.

Basically, the embodiment includes grading software written in the Microsoft Visual Basic language stored in an IBM compatible PC computer with Microsoft Windows Operating System and a word processor. In the grading software, a file-name of a receiving-reference-file and those of receiving-student-files are file-names for receiving data from the respective input-files of reference-file and student-files outside the computer. A file-name for the received-reference-file is chosen from a commonly-used word. File-names for the received-student-files are created from the same word with different numbers in the ascending, numerical order as suffixes. Similarly, file-names for output-files are made in the same way by using the same word with different, numerical suffixes. They are for storing the grading results. In addition, a number of the output-files and receiving-student-files are equal to the number of students in an average class-size.

The computer uses grading software with a GUI to electronically compare data in two, different, plain, text files, namely, student-files with a reference-file in grading. The reference-file contains class-related information as a reference-file-identification, and only data of the right answers to the questions in the homework. A teacher makes it, gives its file-name to match the one of the receiving-reference-file in the grading software, and stores it in an RSD. The student-files also contain class-related information as student-file-identifications, and data of the answers believed to be the right answers of the questions in the same homework. Students make them, give their file-names to match those of the receiving-student-files in the grading software, and store them temporarily in any data storages.

The students need to deliver their student-files to their teacher for grading. They can either submit them in-person to their teacher or e-mail them as the file-attachments to their teacher. If they choose the latter means of forwarding their student-files, the student-file-identifications will help the teacher sort out the e-mails in his or her′ “Inbox.” After the teacher has identified students' e-mails of his or her class, he or she will transfer the file attachments of the student-files in the e-mails and store them together with his or her reference-file in the same RSD.

The crucial part of the embodiment is giving the file-names of the student-files to match those of the receiving-student-files in the grading software. The teacher helps his or her students give file-names of their student-files by assigning them to name their student-files according to the order in which their names are listed in the class roster. As a result, the file-names of their student-files also have numerical suffixes. The numerical suffixes in the file-names have many, useful purposes. The most, useful one is to help the teacher detect unaccountable or missing student-files in his or her RSD by just looking for the discontinuity of the suffixes in the file-names in all the student-files. The reason is that the discontinuity of the numerical suffixes is caused by the missing of the student-files. Thus, looking for the discontinuity is a quick and easy way for the teacher to determine whether or not the RSD has any missing student-files. If it does, the teacher will use filler-files to substitute for them before the grading. He or she makes the filler-files in the same way by using a word processor, fills them with irrelevant or “no” data and names them to match those of the missing student-files.

After attaching the RSD to the computer, he or she will apply a scoring weight or weights and start scoring students' work by using the GUI. The grading results, which include the student-file-identifications, final scores, grades in percentage-numbers and letter-grades and corrections of the wrong answers, will be stored in the output-files whose contents can be manually printed out. Some of the results from the electronic grading are included as items in the list box in the GUI. The items will be visibly shown in the list box at the end of the grading.

### BRIEF DESCRIPTION OF THE DRAWINGS

FIG. 1 is a block diagram illustrating the key steps in implementing the embodiment in accordance with the current application.

FIG. 2 is a diagram illustrating an exemplary GUI screen of the grading software of the embodiment for teachers to interact with the computer in accordance with the current application.

FIGS. 3a-3b collectively illustrate an exemplary flowchart of the remaining description of the embodiment with one-scoring weight in accordance with the current application.

FIGS. 4a-4b collectively illustrate an exemplary flowchart of the remaining description of the embodiment with two-scoring weights in accordance with the current application.

### DETAILED DESCRIPTION OF THE EMBODIMENT

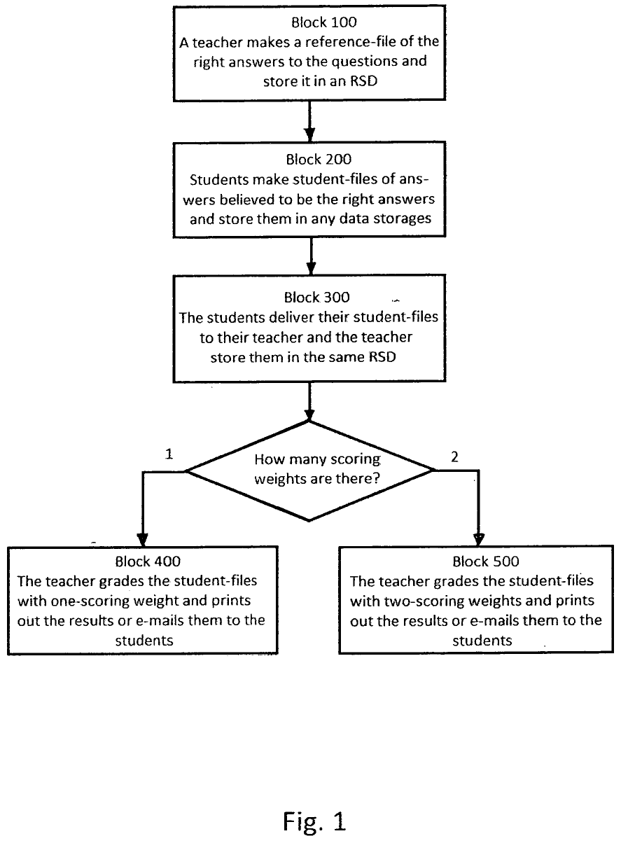

FIG. 1 is a block diagram illustrating the key steps in implementing the embodiment in accordance with the current application.

Block 100 comprises making a reference-file in plain text. The electronically grading software compares data of a student-file with that of a reference-file one data at a time for scoring a student's answer. Thus, before grading, a teacher makes the reference-file containing the data of one answer per line of the right answers to the homework questions with the ordinal numbers by using a word processor like Notepad or Microsoft Word. If the Microsoft Word is used to create a reference-file, making a plain, text file simply saves the finished file in “Plain Text.” The first line of the reference-file contains a reference-file-identification and does not contain any data for grading. It includes class-related information like the period of a class, subject being taught, date of the class and teacher's name in abbreviations, for example, p1/alg2/4-3-2020/M. Jane, which represent period 1, algebra 2, Apr. 3, 2020, Mary Jane.

After the teacher has made his or her reference-file, he or she will give it a file-name to match the one of the receiving-reference-file in the grading software and store it in an RSD. The RSD includes a magnetic-floppy disc or flash drive.

Block 200 comprises making student-files in plain text. Similarly, by using a word processor, students make their student-files containing the data of the answers believed to be the right answers to the questions with the ordinal numbers of the same homework. The arrangement of the contents of the student-files is the same as that of the reference-file, i.e., each of the student-files contains the data of one answer per line, starting from the second line of the student-file onward. Similar to the reference-file, the first line of a student-file contains class-related information as a student-file-identification. It includes the period of a class, subject being taught, date of the class, student's name and e-mail address in abbreviations, for example, p1/alg²/4-3-2020/J. Doe/Jd@gmail.com which represent period 1, algebra 2, Apr. 3, 2020, John Doe, John Doe at the gmail.com website.

After the students have finished in making the student-files of their answers to the questions, they will give their file-names to match those of receiving-student-files in the grading software. The teacher assigns them to name their student-files according to the order in which their names are listed in the class roster. After having finished making their student-files, they will temporarily store their student-files in RSD's or the document folders of the word processors in their computers for facilitating deliveries of them to their teacher for grading. The RSD's used for storing the student-files include magnetic-floppy discs or flash drives.

Block 300 comprises deliveries of the student-files to their teacher and storages of them in the teacher' RSD. The deliveries include students' submitting their student-files in-person to their teacher. The teacher accepts their student-files by transferring them from the students' RSD's or the document folders of the word processors in the students' computers to his or her own RSD. The other means of deliveries of the student-files to their teacher includes e-mailing their student-files as the file attachments through the Internet or intranet. When e-mailing is used as a method of deliveries, each of the students enters the student-file-identification in the “Subject” line on the e-mailing page of an e-mail program. Upon arriving of the e-mail to the teacher' “Inbox,” the student-file-identification becomes the title of the received e-mail. Hence, the teacher can easily recognize the student's e-mail among other e-mails in the same “Inbox” by noticing the title of the received e-mail. Once the teacher has identified the e-mails of the students of the same class, he or she will transfer the attached student-files In the e-mails and stores them together with the reference-file in the same RSD.

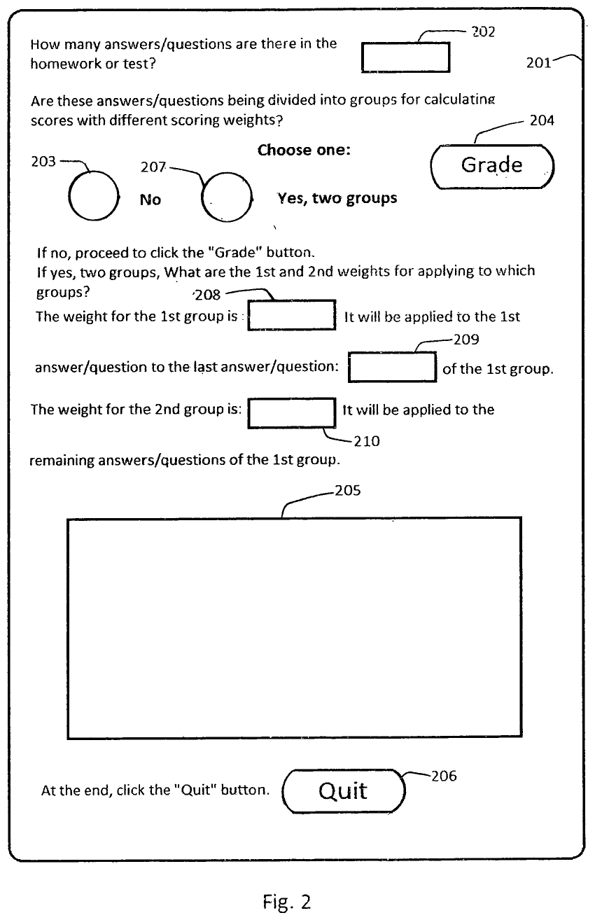

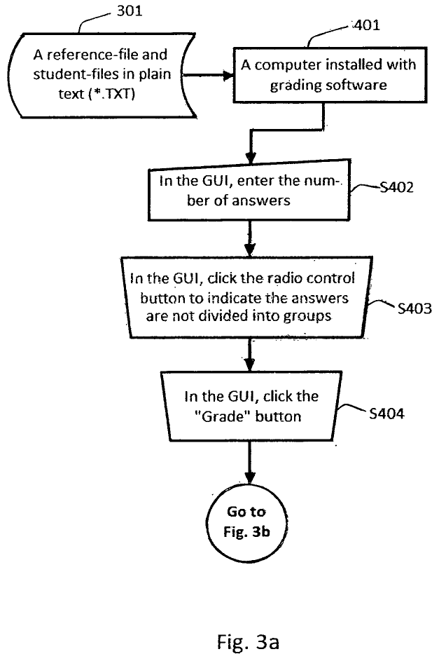

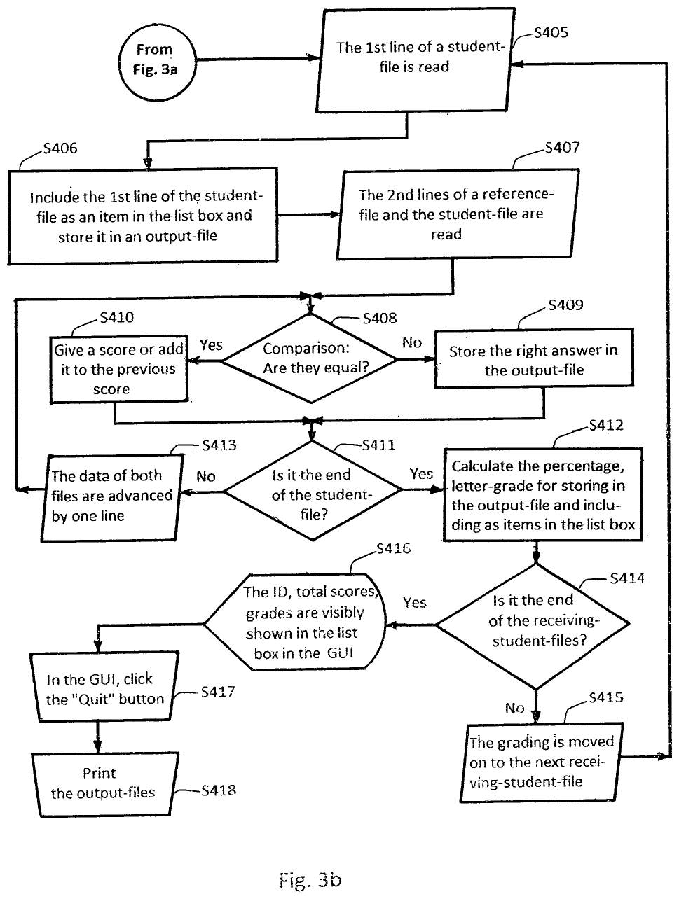

Block 400 comprises the remaining part of the description of the embodiment with one-scoring weight in accordance with the current application. The full description of the embodiment with one-scoring weight includes Blocks 100, 200, 300 and 400 in FIG. 1. FIGS. 3a-3b are flowcharts which collectively illustrate an exemplary flow of the remaining description of the embodiment with one-scoring weight. FIGS. 2 and 3a-3b are now being used to further describe the remaining part of the description of the embodiment.

FIG. 2 illustrates a diagram of an exemplary screen of a GUI 201 of the grading software. A computer 401 shown in FIG. 3a is a general purpose IBM compatible PC, has been installed with Microsoft Windows Operating System, Microsoft Visual Basic and a word processor. More importantly, it has been installed with the grading software written in the Visual Basic language for the electronically grading.

Containing in the grading software, the file-name of the receiving-reference-file and those of receiving-student-files are the receiving-files of data from a reference-file and student-files of matching file-names, respectively. A file-name for the receiving-reference-file is chosen from a commonly-used word like “teacher.” File-names for the receiving-student-files are created from one commonly-used word like “student” with different numbers in the ascending, numerical order as suffixes, for example, student1, student2, student3, . . . , student35, etc.

In the grading software, there also are output-files. Similarly, file-names for the output-files are made from the same word like “output” with different numbers in the ascending, numerical order as suffixes, for example, output1, output2, output3, . . . , output35, etc. The output-files are for storing the grading results. In addition, a number of the output-files and the one of the receiving-student-files in the grading software are determined by the number of students in an average class-size.

FIG. 3a shows an RSD 301 which has been stored with a reference-file and student-files of the same class. It originated in Block 100 when it was loaded with a reference-file and filled with student-files in Block 300.

Before grading students' work, the teacher will check to determine whether or not RSD 301 has contained all of the student-files in his or her own class. First, he or she needs to find out how many students there are in his or her class. Then, he or she counts the number of student files in RSD 301. If both numbers are equal, this will imply that RSD 301 has contained all of the student-files. However, if they are not equal, this will imply that RSD 301 has not contained all of the student-files.

Alternatively, he or she closely looks at the names of all of the student-files in RSD 301. If the numerical suffixes in the names of all of the student-files form a complete set of continuous numbers in the ascending, numerical order, this will imply that RSD 301 has contained all of the students-files in his or her class. For example, if there are 20 students in his or her class, and there are 20 student-files in RSD 301, the numbers in suffixes will form a continuous set of numbers in the ascending, numerical order like {1 2 3 4 5 6 7 8 9 10 11 12 13 14 15 16 17 18 19 20}. However, if an unknown number of students did not send in their student-files, there would be an unknown number of unaccountable student-files. Consequently, the numbers in suffixes might now form a discontinuous one like {1 2 3 4 5 6 7 8 9 10 11 12 14 15 16 18 19 20}. In it, there are two-missing numbers, 13 and 17. They indicate that two students did not send in their student-files. The two-missing numbers, 13 and 17, further point to two unaccountable or missing student-files, student13 and student17. After knowing that student-files, student13 and student17, were missing from RSD 301, the teacher will use filler-files to substitute for them. He or she makes the filler-files in the same way by using the same word processor, fills them with irrelevant or “no” data and gives student13 and student17 as the file-names of the filler-files.

Incidentally, the grading software has been designed to accept data from student-files of a number of students in an average class-size to grade at one time. Sometimes, a class has fewer students than those in the average class-size; thus, there will be fewer students to send in their homework. Consequently, there will be fewer number of student-files received than those of the receiving-student-files in the grading software. In order to use this software to grade students' work properly, the teacher needs to fill RSD 301 with a number of filler-files equal to the difference between the number of the receiving-student-files and the actual number of students assigned to a class. For example, if the grading software has been designed to be able to receive data from 35 student-files to grade at one time; thus, 35 student-files will be required as input-files for the grading software to work properly. If there are only 30 students actually assigned to be in a class, there would be 30 student-files sent by the students. Hence, there would be 35−30=5 student-files short from the required number of input-files. The teacher needs to uses five filler-files to fill into RSD 301 to make up for the inadequate number of the student-files.

In order to avoid doing unnecessary work, after the teacher has graded student's work in RSD 301, he or she can leave the old filler-files in RSD 301 for using as the filler-files again in the following grading. However, the file-names of the old filler-files must be changed to different ones to prevent them from interfering with storing new student-files which may have the same file-names as those of the old filler-files. After other, old files have been removed from RSD 301, it can be reused for storing with a new reference-file and student-files.

After the teacher has attached RSD 301 to computer 401 through the magnetic-floppy-disc bay, if RSD 301 is a magnetic-floppy disc, or through the USB port, if RSD 301 is a flash drive, he or she can start electronically grading of students' work. First, in Step S402, he or she uses a computer-keyboard to type a textual number representing the data of a number of answers in homework in an input-text box 202 in GUI 201. Then, he or she uses a computer-mouse to click a radio-control button 203 in Step S403 to indicate that the answers are not divided into groups in calculating the scores. Finally, he or she activates the grading software by using the computer-mouse to click the activation-button which is called the “Grade” button 204 in GUI 201 in Step S404. Consequently, the grading software is being executed.

Corresponding to a receiving-student-file in the grading software, the first line of the student-file in RSD 301 is read in Step S405. It contains a student-file-identification. In Step S406, the student-file-identification is stored in an output-file and included as an item in a list box 205 in GUI 201. In Step S407, the second lines of data in the student-file and reference-file are read, which correspond to the respective receiving-student-files and receiving-reference-file in the grading software. They contain the data of the answer believed to be the right answer to the question in the student-file and that of the right answer to the same question in the reference-file. The data from the student-file is electronically compared with that from the reference-file for scoring in Step S408, if the answer in the comparison is “No,” which will indicate that the data of both files are not electronically equal; thus, the student's answer was wrong. The data of the right answer with the ordinal number will be copied from that in the reference-file and stored in the output-file in Step S409. However, in the comparison in Step S408, if the answer is “Yes,” which will indicate that the data of both files are electronically equal; thus, the student's answer was right, in Step S410, a score will be given to the maker of the student-file. Depending on what stage the grading is in, it will be added to the previous score until grading all the data of the answers in the student-file. The resulting score will be a total score of the maker of the student-file. The total score will be included as an item in list box 205 and stored in the output-file.

After the comparison of Step S408 has been completed in either Step S409 or Step S410, the grading is moved to Step S411 for the computer to check to determine whether or not it has been the end of the student-file. If the answer is “No” in Step S411, which will indicate that it has not been, the grading procedure will be moved from Step S411 through Steps S413, S408, S409 or S410 and back to Step S411 in a loop-like manner. The flow of the grading procedure will be repeated in going around in a loop to do the same things over again, if the answer in Step 411 is always “No.” This flow of the grading procedure was like a “Do” loop in some computer, programming languages. Since the looping was directed to go through a first path in grading the data from the student-file, it was called a first “Do” loop. However, if the answer in Step S411 is “Yes,” which will indicate that it has been the end of the student-file and also the end of the first “Do” loop. Then, in Step S412, the computer will calculate the grades in a percentage-number and letter-grade of the total score of the maker of the student-file. The grades will be included as items in list box 205 and stored in the output-file.

From Step S412, the grading is moved on to Step S414 for the computer to check to determine whether or not it has been the end of the receiving-student-files. If the answer in Step S414 is “No,” which will indicate that it has not been, the grading procedure will be moved from Step S414 through Steps S415, S405, S406, S407, the first “Do” loop, “Yes” in Step S411, Step S412 and back to Step S414 in a loop-like manner again. If the answer in Step S414 is always “No,” the flow of the grading procedure will be repeated in going around in a loop to do the same things over again, creating a second “Do” loop. It was so called, because the looping was directed to go through a second path in grading the student-file corresponding to a receiving-student-file in the grading software. However, if the answer in Step S414 is “Yes,” which will indicate that it has been the end of the receiving-student-files and the end of the second “Do” loop and ultimately, the end of the grading of all of the student-files stored in RSD 301.

Finally, the items in list box 205 in GUI 201 are visibly shown in Step S416. They comprise the student-files-identifications, students' total scores, grades in percentage-numbers and letter-grades. The grading program can now be terminated by using the computer-mouse to click the end-button which is called the “Quit” button 206 in Step S417. The teacher can manually use the word processor to print out the grading results in the output-files with a printer in Step S418. They include the student-file-identifications, students' total scores, grades in percentage-numbers and letter-grades, and right answers of students' wrong answers with the corresponding ordinal numbers of students' wrong answers in the student-files. Alternatively, he or she can e-mail the output-files with an e-mail program as the file attachments through the Internet or intranet to his or her students by using the students' email addresses in the student-file-identifications.

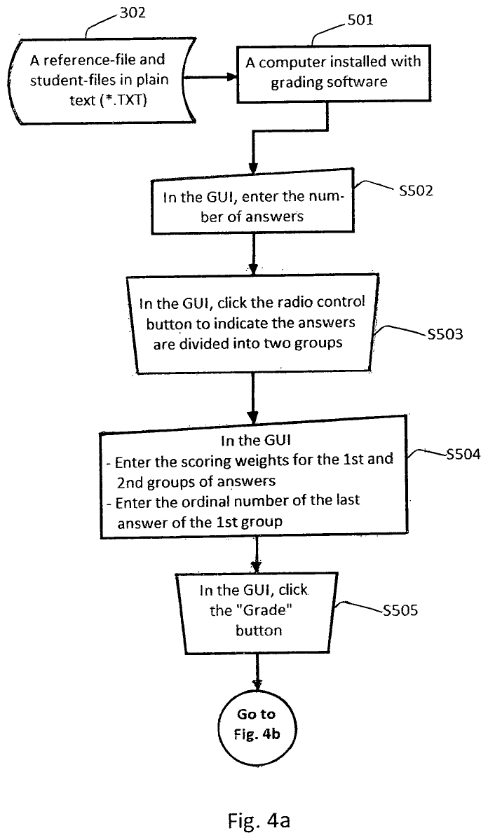

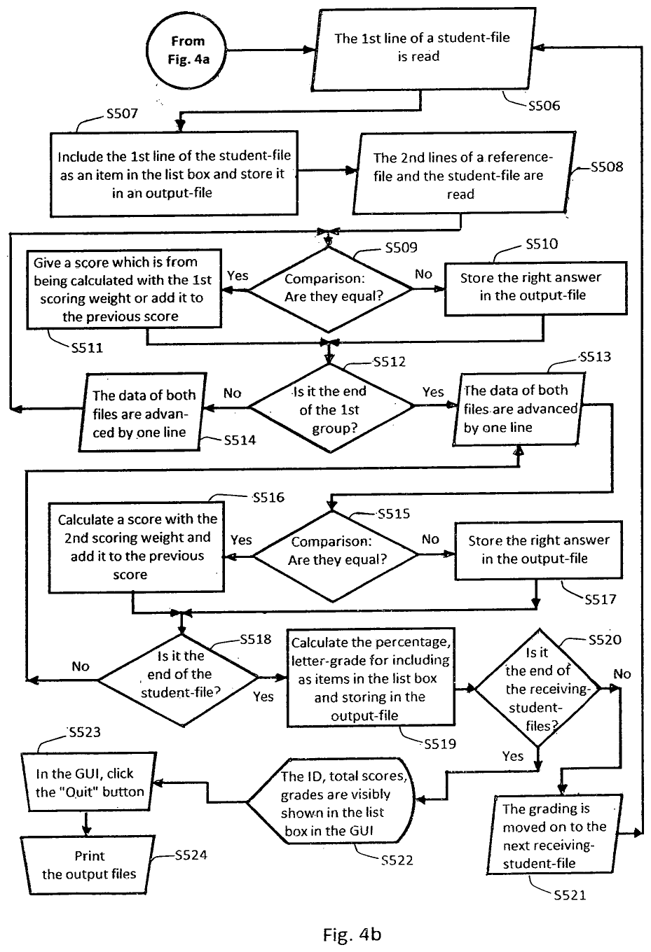

Block 500 comprises the remaining part of the description of the embodiment with two-scoring weights in the current application. The full description of the embodiment with two-scoring weights includes Blocks 100, 200, 300 and 500 in FIG. 1. FIGS. 4a-4b are flow charts which collectively illustrate an exemplary flow of the remaining description of the embodiment with two-scoring weights in accordance with the current application. FIGS. 2 and 4a-4b are now being used to further describe the remaining part of the description of the embodiment with two-scoring weights.

A computer 501 shown in FIG. 4a is the same computer as computer 401 in FIG. 3a. It also has been installed with the same grading software and other software mentioned in Block 400. FIG. 4a shows an RSD 302, which has been filled with a reference-file and student-files in the same way as RSD 301 has been as described in Blocks 100, 300.

In addition to Block 200 about making the student-files, and in regarding to grading students' work with two-scoring weights, the teacher has to predetermine the difficulties of his or her homework questions and then, separates them into two groups according to the degree of difficulties of the homework questions before assigning them to his or her students. The questions in the first group may be more difficult than those in the second group or vice versa. During the separation of the questions into two groups, the teacher needs to remember the ordinal number of the last question of the first group, because he or she will need to use this information in order to continue in the grading. Furthermore, as a result of the separation of questions into two groups, the data of the answers in the student-files in RSD 302 are automatically divided into two groups for them to be scored with two-scoring weights.

Before grading students' work, the teacher will also check to determine whether or not RSD 302 has contained all of the student-files and required filler-files before using the computer-mouse to click “Grade” button 204 as explained in Block 400 regarding to the remaining part of the description of the embodiment with one-scoring weight in accordance with the current application.

After the teacher has attached RSD 302 to compute 501, he or she can start grading students' work with two-scoring weights by first, using the computer-keyboard to type a textual number representing the data of a number of the answers in input-text box 202 in Step S502. Then, the teacher uses the computer-mouse to click a radio control button 207 in GUI 201 in Step S503 to indicate that the answers are divided into two groups in calculating the scores with different, scoring weights. In Step S504, with the computer-keyboard, he or she types a textual number representing the data of the scoring weight for calculating the scores of the data of the right answers of the first group in an input-text box 208, a textual number representing the data of the scoring weight for calculating the scores of the data of those of the second group in an input-text box 210, and a textual number representing the data of the ordinal number of the last answer of the first group in an input-text box 209. Finally, the teacher can activate the grading software by using the computer-mouse to click “Grade” button 204 in GUI 201 in Step S505. Consequently, the grading software is being executed.

Corresponding to a receiving-student-file in the grading software, the first line of the student-file in RSD 302 is read In Step S506. It contains a student-file-identification. In Step S507, the student-file-identification is stored in an output-file and included as an item in list box 205 in GUI 201. In Step S508, the second lines of both files, namely the student-file and reference-file, are read for grading, which correspond to the respective receiving-student-files and receiving-reference-file in the grading software. They contain the data of the answer believed to be the right answer to the question in the student-file, and the data of the right answer to the same question in the reference-file. In Step S509, the data from the student-file is electronically compared with that from the reference-file. If the answer in the comparison is “No,” which will indicate that the data in both files are not electrically equal; thus, the student's answer was wrong. The data of the right answer with the ordinal number will be copied from that in the reference-file and stored in the output-file in Step S510. However, if the answer is “Yes” in Step S509, which will indicate that the data of both files are electronically equal; thus, the student's answer was right, in Step S511, a score will be calculated with the first, scoring weight and given to the maker of the student-file. Depending on what stage the grading is in, it will be added to the previous score until grading all the data of the answers in the first group.

After the comparison of Step S509 has been completed in either Step S510 or Step S511, the grading is moved to Step S512 for the computer to check to determine whether or not it has been the end of the data of the answers of the first group. If the answer in Step S512 is “No,” which will indicate that it has not been, the grading procedure will be moved from Step S512 through Steps S514, S509, S510 or S511 and back Step S512 in a loop-like manner. The flow of the grading procedure will be repeated in going around in a loop to do the same things over again, if the answer in Step S512 is always “No,” creating a first “Do” loop. It was so called, because the looping was directed to go through a first path in grading the data of the answers of the first group. However, if the answer in Step S512 is “Yes,” which will indicate that it has been the end of the data of the answers of the first group and also the end of the first “Do” loop. In Step S513, the data of both files are advanced by one line for them to be compared later in Step S515. If the answer in Step S515 is “Yes,” which will indicate that the data of both files are electronically equal; thus, the student's answer was right. In Step S516, a new score will be calculated with the second, scoring weight and added to the previous score of the maker of the student-file until grading all the data of the answers in the student-file. The resulting score will be a total score of the maker of the student-file. The total score will be included as an item in list box 205 and stored in the output-file.

However, if the answer is “No,” in Step S515, which will indicate that the data of both files are not electronically equal; thus, the student's answer was wrong. The data of the right answer with the ordinal number will be copied from that in the reference-file and stored in the output-file in Step S517.

After the comparison of Step S515 has been completed in either Step S516 or Step S517, the grading is moved to Step S518 for the computer to check to determine whether or not it has been the end of the student-file. If the answer in Step S518 is “No,” which will indicate that it has not been, the grading procedure will be moved from Step S518 through Steps S513, S515, S516 or S517 and back to Step S518 in a loop-like manner. The flow of the grading procedure will be repeated in going around in a loop to do the same things over again, if the answer in Step S518 is always “No,” creating a second “Do” loop. It was so called, because the looping was directed to go through a second path in grading the data of the answers in the second group of the answers in the student-file. However, if the answer In Step S518 is “Yes,” which will indicate that it has been the end of the student-file and also the end of the second “Do” loop. In Step S519, the computer will calculate grades in a percentage-number and letter-grade of the total score of the maker of the student-file. The grades will be included as items in list box 205 and stored in the output-file.

From Step S519, the grading is moved on to Step S520 for the computer to check to determine whether or not it has been the end of the receiving-student-files. If the answer in Step S520 is “No,” which will indicate that it has not been, the grading procedure will be moved from Step S520 through Steps S521, S506, S507, S508, the first “Do” loop, “Yes” in Step S512, the second “Do” loop, “Yes” in Step S518, Step S519 and back to Step S520 in a loop-like manner. The flow of the grading procedure will be repeated in going around in a loop to do the same things over again, if the answer in Step S520 is always “No,” creating a third “Do” loop. It was so called, because the looping was directed to go through a third path in grading the student-file corresponding to a receiving-student-file in the grading software. However, if the answer In Step S520 is “Yes,” which will indicate that it has been the end of the receiving-student-files in the grading software and also the end of the third “Do” loop and ultimately, the end of the grading all of the student-files in RSD 302.

Finally, the items in list box 205 in GUI 201 are visibly shown in Step S522. They comprise the student-file-identifications, students' total scores, grades in percentage-numbers and letter-grades. The grading program can now be terminated by using the computer-mouse to click “Quit” button 205 in Step S523. The teacher can manually use the word processor to print out the grading results in the output-files with a printer in Step S524. They include the student-file-identifications, students' total scores, grades in percentage-numbers and letter-grades, and right answers of students' wrong answers with the corresponding ordinal numbers of the students' wrong answers in the students-files. Alternatively, he or she can e-mail the output-files with an e-mail program as the file attachments through the Internet or intranet to his or her students by using the students' email addresses in the student-file-identifications.

### Advantages

From the description above, one can visualize a number of advantages of the embodiment described in the current application. The advantages include:

(a) The grading software in this embodiment has a GUI which gives teachers some conveniences in using a computer to grade students' work. By a click of the computer-mouse, they can start, stop the program, or apply different-scoring weights effortlessly to calculate the scores to reflect the degree of difficulties of homework questions.

(b) The grading software in this embodiment doesn't need editing or modifying to grade students' work from different classes. As a result, teachers with little or no programming skills will be able to use this grading software.

(c) The grading software in this embodiment can score textual answers. Students will be able to send their answers in texts to their teachers for electronically grading. Thus, it will eliminate the requirements of using multiple-choice questions and answer sheets.

(d) The embodiment described in this current application help teachers finish grading their students' homework sooner. As a result, students will get their graded homework back before they will forget all about what they did in the homework. This will enable students to dissect their wrong answers so that they learn from their errors.

(e) The embodiment described in this current application gives feedbacks in the forms of graded homework for informing students about their efforts in doing homework and understandings in the subjects being taught.

(f) The embodiment in this current application greatly reduces teachers' time in grading students' homework.

(g) The embodiment in this current application gives teachers more time to write lesson plans.

### CONCLUSION, RAMIFICATION AND SCOPE

Accordingly, one will see the methods for grading scholastic work of this embodiment can be used to grade students' work with less time, easily and conveniently. Teachers don't need to get online to post their homework on database servers. As a result, they will not waste their time in making homework questions necessary for posting on them. The embodiment of this current application has the additional advantages in that:

(a) The cost of an implementation of this embodiment is very low. Most schools can afford to use this grading software, because most of the computer programs for this implementation are free. Some software like the text editor, Notepad, comes with Microsoft Windows Operating System. If students do not have the Microsoft Windows Operating System in their computers, they will be able to get it for free by downloading the Notepad from the Internet. They will need this text editor to make the plain text files of their answers to questions in homework. Fortunately, they won't have to pay money out from their own pockets to buy this text editor.

(b) Other components for the implementation are also inexpensive. Regular personal computers or existing computers in the schools can be used or re-purposed for this implementation.

Although the embodiment of the current application for a patent has been disclosed in details and contained many specificities, these disclosures should not be construed as limiting the scope, but as merely providing some illustrations of several, other embodiments which are apparent to people who are skilled in the art. For example, teachers can store student-files and reference-files in different, document folders in the word processors in teachers' computers instead of storing them in many RSD's. Teachers can use several e-mail accounts to receive e-mails from their students to avoid sorting out students' e-mails. The grading software can also have more than two, different, scoring weights. Thus, the scope should be determined by the appended claims and their legal equivalents rather than by the embodiment disclosed.

What being claimed is:

1. A computer-implemented method for electronically scoring answers to questions in homework from a class of students which have been organized into a data file and providing the results thereof, said method comprising:
a. providing a computer having a screen for automatically displaying the human-accepted form of data from the output-interface of said computer, wherein said output-interface is a device which automatically and electronically transforms digital information into said human accepted form of data;
b. automatically receiving data for electronically scoring after being started by using file-names of two, different, receiving files in said computer, namely receiving-student-files to receive the data from student-files, and a receiving-reference-file to receive the data from a reference-file of said matching file-names, wherein the file-names of said receiving-student-files have the predetermined file-names which comprise the same word with different numbers in the numerical order as suffixes, and the one of said receiving-reference-file comprises a recognizable file-name;
c. providing said student-files in plain text made manually by students with a word processor, which are input-files and given their file-names to match those of said receiving-student-files, comprise student-file-identifications and one data per line of the answers believed to be the right answers to the homework questions, wherein said student-identifications are class-related information to give the unique identities of said student-files;
d. providing said reference-file in plain text made manually by a teacher with said word processor, which is an input-file and given its file-name to match the one of said receiving-reference-file and comprises one data per line of the right answers with their ordinal numbers to said same, homework questions;
e. providing an RSD for storing said student-files and reference-file to automatically supply the data from said student-files and reference-files for said electronically scoring after being attached to said computer, wherein said RSD is able to automatically store the data from said word processor, supply the data to said computer, be manually attached to and removed from said computer;
f. electronically interacting between said teacher with said computer by using the GUI which is a graphical display generated automatically on the screen of said computer,
wherein said GUI has the specific-area, which is responsive to electronic data being applied on and associated with a pre-specified task, for activating said computer to perform said pre-specified task,
and said GUI has the window, which is a blank area and able to display said human accepted form of data, for said computer to include and display data resulting from said electronic scoring;
g. providing a means for manually starting said electronically scoring by said teacher using an input-interface to give said electronic data directly or indirectly onto said specific-area in said GUI, which is associated with the starting said electronically scoring, to electronically activate said computer to start said electronically scoring,
and automatically displaying by said computer using said window in said GUI to display said data resulting from said electronic scoring;
h. providing said input-interface being a device for giving said electronic data directly or indirectly onto said specific-area which is associated with said pre-specified task, to electronically activate said computer to perform said pre-specified task;
i. automatically getting said student-file-identification from each of said student-files by automatically copying it from each of said student-files during said electronically scoring the data from each of said student-files from said RSD, and automatically including said student-file-identification as an item in said window after said automatically copying said student-file-identification;
j. providing an output-file for automatically storing said student-file-identification of each of said student-files in said RSD after said automatically copying, wherein said output-file is a storage file and accessible by said teacher for manually e-mailing as the file attachment and able to store data for manually printing out;
k. automatically comparing electronically one data at a time the data in said student-file with that in said reference-file during said electronically scoring;
l. automatically giving a score to the student who made said student-file when said electronically comparing of the data results in the equality, indicating the answer, represented by the data in said student-file, was right,
and automatically adding the scores from said electronically giving a score to yield a total score of said student, while each of the data is being electronically compared and the answer was right until the end of said electronically giving a score,
and automatically including said total score as an item in said window and storing in said output-file after said automatically adding the scores;
m. automatically getting the data of said right answer with its ordinal number from said reference-file by automatically copying it from said reference-file, if said electronically comparing results in the inequality, indicating the answer in said student-file was wrong during each of the data in each of said student-files from said RSD is being compared electronically,
and automatically storing the data of said right answer with its ordinal number in said output-file during said electronically comparing each of the data in each of said student-files from said RSD after said automatically copying.

2. The method in claim 1, further including automatically calculating a percentage-number of said total score of said student by using the regular-mathematical formula for calculating the percentage at the end of said electronically scoring the data from each of said student-files from said RSD,
and automatically including said percentage-number as an item in said window and storing in said output-file after said automatically calculating.

3. The method in claim 1, further including automatically assigning a letter-grade to said total score of said student by using an alphabetical symbol to represent said final score of said student to indicate that said total score falls within a certain-score range represented by said alphabetical symbol at the end of said electronically scoring the data from each of said student-files in said RSD, and automatically including said letter-grade as an item in said window and storing in said output-file after said automatically assigning.

4. The method in claim 1, further including providing a means of using said GUI for said teacher to optionally and manually apply different, scoring weights onto two, separate groups, namely the first and second groups of the data of the right answers for automatically calculating electronically the scores,
wherein said two separate groups of the right answers were from the results of manually pre-separating said homework questions by said teacher into two groups based on the degree of difficulties of said homework questions.

5. The method in claim 4, wherein said means includes said GUI having the specific-area, which is responsive to said electronic data being applied on, and associated with optionally and manually indicating answers having been divided into two groups to be calculated with said different, scoring weights, for said teacher to use said input-interface to give said electronic data directly or indirectly onto said specific-area to electronically activate to said computer to automatically calculate electronically the scores of the data of the right answers of said two groups of answers with said different, scoring weights,
and having the two, input-text boxes, which are empty boxes and each of said text boxes can accommodate a textual number being typed in manually with a computer-keyboard, for electronically receiving said two, textual numbers representing the data of the first and second scoring weights for said computer to automatically calculate electronically the scores the data of the right answers of the first and second groups from said electronically scoring, respectively.

6. The method in claim 5, further including said GUI having said another input-text box for electronically receiving a textual number, being manually typed in with said computer-keyboard, and representing the data of the ordinal number of the last answer of the first group of answers for electronically indicating to said computer to automatically start calculating electronically the scores with the data of the second, scoring weight for the data of the right answers of the second group.

7. The method in claim 1, further including providing a means for manually printing out the contents of said output-files by said teacher using said word processor to print said contents with a printer, after the data from all of said student-files in said RSD has been electronically scored.

8. The method in claim 1, further including providing a means for manually e-mailing said output-files as the file attachments to said students by said teacher using an e-mail program to e-mail said output-files as the file attachments through the Internet or intranet, after the data from all of said student-files in said RSD has been electronically scored.
